(19) United States
(12) Patent Application Publication
(10) Pub. No.: US 2004/0196264 A1
(43) Pub. Date: Oct. 7, 2004

(54) Keypad input device

(76) Inventor: John C. Criscione, College Station, TX (US)

Correspondence Address: MINTZ LEVIN COHN FERRIS GLOVSKY AND POPEO PC, 12010 SUNSET HILLS ROAD, SUITE 900, RESTON, VA, 20190, US

(21) Appl. No.: 10/813,396

(22) Filed: Mar. 31, 2004

Related U.S. Application Data
(63) Continuation-in-part of application No. 10/653,511, filed on Sep. 3, 2003.
(60) Provisional application No. 60/407,295, filed on Sep. 3, 2002.

(51) Int. Cl. G09G 5/00

(52) U.S. Cl. 345/168

(57) ABSTRACT

A single-handed keypad includes a first portion movable in two or three dimensions relative to a base. The character values for the keys comprising the keypad may be changed based upon the position of the first portion relative to the base. The keypad may further include a base. The movement of the first portion of the keypad is also used to control a pointer. The keypad includes keys, operable by a user's thumb, which are positioned in adjacent, orthogonal planes such that they may be operated either individually, or simultaneously in combination.

### CROSS-REFERENCE TO RELATED APPLICATIONS

This Application is a continuation-in-part of U.S. patent application Ser. No. 10/653,511, filed Sep. 3, 2003, which claims priority to U.S. Provisional Patent Application Serial No. 60/407,295, filed Sep. 3, 2002, each of which are hereby incorporated herein by reference in their entirety.

### FIELD OF THE INVENTION

The invention relates generally to an input device, and more particularly to a single-handed computer keypad with keys representing different character values or commands based on multi-dimensional, translational movement of the keypad.

### BACKGROUND OF THE INVENTION

Operation of a computer or other processing device may depend, in part, on a user inputting data or commands via an input device. Various devices are known for inputting data and commands including, for example, keyboards, keypads, mice, trackballs, joysticks, game controllers, voice recognition systems, wired or wireless remote controllers, or other input devices.

Several drawbacks and limitations exist, however, with known input devices. These drawbacks and limitations are often accentuated when individuals afflicted with hand disabilities, repetitive stress injuries, and arthritis attempt to navigate the human-computer interface. With the growing use of computers for communication, entertainment, composition, and information storage, retrieval, and analysis, an injury to even one finger of one hand may significantly impact a person's performance and outlook, both at home and in the work-place. Even for people without disabilities, there is need for improvement in the human factors and ergonomics of computer input devices.

“QWERTY” keyboards, for example, tend to be the industry standard for desktop and portable computers. These keyboards are generally bulky and are principally designed for operation by two hands. With two-handed touch typing, individuals, on average, may input approximately sixty words per minute. Proficiency with “QWERTY” keyboards typically comes after many weeks of use, but may be significantly diminished by hand disabilities or injuries. Overuse of this type of keyboard is a primary cause of repetitive stress injury of the hands.

Smaller keyboards have been designed, but are often difficult to use as the size of the keys are often reduced. In addition, smaller keyboards generally do not allow effective use by a single hand. Other types of input devices often lack the range of functions which may be realized using full-sized keyboards. Specifically, other input devices have fewer controls for performing limited kinds of operations. Therefore, a need exists for a device which allows inputs of all characters and functions, but which is smaller than a full-size “QWERTY” keyboard, and easily operable by one hand.

In addition to smaller keyboards referenced above, various compact keypads have been designed. In general, such compact keypads, including one-handed character input devices, provide some sort of multiplicity for each key comprising the keypad, such that a reduced number of keys can represent a full character set. A common method for obtaining key multiplicity is key-chording. Key-chording uses key combinations, pressed or activated simultaneously or in sequence, to represent characters. A variation of the key-chording technique is the use of a selector switch. The keys on the keypad represent different characters depending upon the current position of the selector switch.

While key-chording provides key multiplicity and allows for a keypad with fewer keys than a full keyboard, it is a complex technique which must be mastered by the user. A user must learn which combinations of keys create each character. Furthermore, great precision is required during use to ensure that the sets of keys are pressed simultaneously or in the proper sequence. If keys are not activated simultaneously, an incorrect set of characters may result. Therefore, a need exists for a simple, compact keypad which can easily represent all of the characters on an ordinary keyboard.

Another known, but less common technique for inputting data and commands, is keypad-transplacement. Despite the improvements in keypad design using known keypad-transplacement techniques, various deficiencies exist. In at least some implementations, possible keypad positions are limited along a single axis of rotation or movement, which provides only three possible values for each of the keys. Additionally, a separate trackball or other device may be required for cursor or pointer positioning, or other movement commands in multiple dimensions.

One or more of the foregoing keyboards, keypads, or other input devices may also experience other problems which may limit their use. For instance, some input devices are designed to operate with only a specific hand (e.g., the right hand). This may be difficult for left-handed people, or for individuals with disabilities.

In addition, some computer programs require simultaneous operation of certain keys for additional functionality. For example, the “ctrl,” “alt,” and “shift” keys on an ordinary keyboard, when used in various combinations with other keys, may perform certain functions in various applications such as, for instance, Microsoft Word® from Microsoft Corporation. Some alternative keypads do not include these keys or the possibility of simultaneous operation of such keys.

Furthermore, with many compact keypads, users may have difficulty remembering the combination of keys, or combinations of position and keys, which generate specific characters or perform specific functions. As with any new input device, extensive practice is required to learn and become familiar with the operation. However, most keypads do not provide effective aids to assist the novice user. Often the characters are solely on the keys, which are covered by the user's fingers during operation.

Some input devices have incorporated thumb or finger scrolls. Such devices simplify scrolling and other functions when viewing documents. Nevertheless, compact keypads typically have not incorporated scroll devices.

Additionally, keyboards and keypads are often uncomfortable for users. Incidents of carpal tunnel syndrome have increased in recent years as people have increasingly used awkward input devices. Various accessories, such as pads and supports, have been developed for computer users to ease the strain on arms, hands, and other body arts that may result from use of conventional keyboards and pads. Nevertheless, a need exists for a keypad which provides comfortable support and easy manipulation.

In addition to the foregoing drawbacks and limitations of known keyboards and keypad devices, many computer systems further rely on a second input device (e.g., a pointer device) to navigate the graphical user interfaces of various software applications. A computer “mouse,” for example, is perhaps the most commonly used input device used to effectuate pointer control. Many individuals often rely on both a keyboard or keypad and a mouse to input data and commands. This may be frustrating for certain applications that may require continual switching from a keyboard to a mouse such as, for instance, when creating and/or editing a word processing document. Alternatively, “quick keys” on a keyboard or keypad may be used primarily to avoid a pointer device altogether. Often, pointer devices on portable computers (e.g., laptop computers) are so poor that laptop users learn to become quite proficient with quick keys.

As the number of different computing platforms expands, more and more devices are being programmed to provide various functions. Many gaming consoles, for instance, now include network (e.g., Internet) connections. Cellular telephones and Personal Digital Assistants (PDA's) also include network connections. WebTV has been developed and deployed. As these and other devices and systems are being designed and/or enhanced, many different control devices are being provided with different functionality. It is not uncommon for a user to need to learn a myriad of interfaces just to control all of his or her electronic devices. Therefore, a need exists for a system which provides a simple, consistent interface to various electronic, computing devices.

These and other drawbacks exist.

### SUMMARY OF THE INVENTION

The invention solving these and other problems relates generally to an input device, and more particularly to a single-handed computer keypad with keys representing different character values or commands based on multi-dimensional, translational movement of the keypad.

According to an embodiment of the invention, an input device is provided which may be compact, and yet offer the full functionality of a full-sized input device (e.g., a full-sized “QWERTY” keyboard). Further, the input device may operate in at least two different modes, and thus as at least two different types of input devices.

According to an embodiment of the invention, the input device may comprise a keypad system that includes a keypad. The keys comprising the keypad may represent different character values or other inputs, each of which may be invoked depending on the position or movement of the keypad when a key is depressed, selected, or otherwise activated. Character values may comprise any letter, number, mathematical operator or symbol, language symbol, command, or any other icon or symbol that may be represented on a keyboard. Further, the term “character values” may be used interchangeably herein with “character.” According to one aspect of this embodiment, the keypad may be moved in one or more linear directions (e.g., front, back, left and right) whereby the direction of movement (or non-movement) causes a key to represent a different character or key value. For example, this approach enables a single key to represent at least five different character values depending on whether the keypad is moved and if so, in which direction it is moved when the key is depressed. Four values may be invoked when moving the keypad is moved forward, backward, left and right. A fifth value may be invoked by selecting or activating a key while the keypad is stationary or in a neutral position. Similar techniques may be used for keys that represent commands (e.g., Enter, Delete, Page Up, Page Down, etc.) or other inputs.

As detailed below, one embodiment of the invention preferably uses two orthogonal directions of linear movement plus no movement (rest position) to enable some or all keys, depressed alone, to represent up to five different character values. In other embodiments, more (e.g., three) or less (e.g., one) dimensions of movement can be used. In alternative embodiments, other types of nonlinear movement (e.g., rocking) and/or the extent of movement, speed of movement, or other movement-related criteria may be used.

According to one embodiment, one or more keys may represent more than one character value or function based on motion (or direction of motion) and at least one key may represent the same value or function regardless of the motion or direction of motion.

According to another embodiment of the invention, the keypad may comprise a combination keypad and pointing device, where in a first mode, the keys of a keypad can represent different character values or other inputs depending on the position or movement of the keypad when the key is depressed or otherwise activated. In a second mode, the movement of the keypad may control the position of a cursor (or other pointing device) or otherwise provide commands for pointer or cursor control. In one implementation, the same motion detection device may be used for both functions. One advantage of this approach is that it eliminates the need for a separate mouse or trackball for control. And unlike full sized keyboards that include a separate pointer control, one or more keys used for the keypad may be used to actuate the pointer.

According to another embodiment of the invention, the keypad of the invention may include a plurality of keys operable by a user's thumb (“thumb keys”), where the thumb keys may be located in close proximity to a thumb position when the user's hand is at rest on the keypad, but are disposed in different orthogonal orientations. For example, the keypad may include at least three thumb keys, whereby one is activated by pushing the thumb forward, one is activated by pushing the thumb down, and one is activated by pushing the thumb sideways. According to another aspect of the invention, these thumb keys may be activated individually or in various combinations to represent different values, commands or other input. The configuration of the thumb keys, on adjacent and orthogonal axes, may be implemented on any number of keyboards (e.g., “QWERTY” keyboards), keypads, or known input devices, in addition to the single-hand keypad disclosed herein.

According to another embodiment of the invention, the keypad may comprise at least two orthogonally disposed thumbwheels (or scroll wheels) which permit scrolling in a first direction (e.g., up and down) and a second direction (e.g., left and right), preferably orthogonal to the first direction. The scroll wheels may be located in close proximity to the thumb position and other thumb keys to enable thumb actuated control of the scroll wheels.

According to another embodiment of the invention, any of the embodiments described herein may be implemented to enable convenient, effective, single-handed operation by a user and may be used equally as well by left-handed or right-handed users. For example, the keypad may have a palm rest so that a user can locate his palm in a single, comfortable position on the palm rest and use his thumbs and fingers to access all of the keys without removing his palm from the single position on the palm rest. The compact nature of the keypad and the reduced number of keys facilitates this while still permitting “full-sized” keys to be used. According to another aspect of the invention, the keypad may include redundant thumb keys to accommodate use by either hand, and provide an otherwise substantially symmetrical layout about a central axis of the keypad.

According to another embodiment of the invention, visual indicators may be provided to facilitate the ability for a user to use the keypad. According to one embodiment of the invention, the visual indicators may be located on the keys themselves, such that the different character values corresponding to a key are each displayed on the key, but are located on the key in a position corresponding to the direction of movement that causes the key to assume that character value. For example, if a key may represent one of five character values when depressed, activated, or otherwise selected (depending on whether the keypad is moved and if so, in which direction it is moved), then the five character values may be displayed in a position on the key relative to the direction of movement that causes the key to assume that value. Alternatively, the keypad may be in operable communication with a display to provide an on-screen display of the keys and corresponding key values based upon the position of the keypad. One of the keys may provide a toggle to enable the user to selectively switch the on-screen display on and off. Other visual indicator techniques may be used on or in conjunction with the keypad.

In some embodiments, the device may be used as a “table-top” device, so that movement along a surface is detected by a roller (or other detection technique such as those used in current pointing devices). In other embodiments, the keypad may be used in “free-space,” such that, for example, the keypad may be worn by a user and movement may be detected without requiring the keypad to be moved along a surface. This aspect of the invention is particularly useful in various mobile applications, including, for example, use with wearable computers and other mobile applications. In this embodiment, movement may be detected by known motion detection techniques. In other embodiments, the keypad is functional in both a table-top mode and a free-space mode and comprises suitable motion detection devices to accommodate both techniques. The mode may be controlled by one of the keys, a toggle switch, or may be automatically detected.

According to another embodiment of the invention, the keypad may incorporate a moldable palm rest. The moldable palm rest may include microspheres under a malleable covering. Upon use, the moldable palm rest may conform to the shape of a user's hand to provide support, and may couple the keypad to the user's hand for easy manipulation.

According to another embodiment of the invention, the keypad may include additional components to act as a computer, portable computer, PDA or other device. The components may include one or more of (or a combination of) a hard drive, CPU, RAM, chipset, etc. The keypad may be linked, by wire, wireless link, optical link or other communications link, to another display device or to other computer equipment. Thus, the invention may provide a single interface for use with many different types of equipment and in variety of applications and environments.

One advantage provided by the keypad is that it is compact and comfortable to use while sitting, standing, or lying down. It may also be used comfortably while standing at a counter or sitting at a standard desk, table, or coffee table. In addition, the keypad may also be used comfortably in one's lap.

Another advantage provided by the keypad is that it is ergonomically designed for maximum wrist and hand comfort with no ulnar deviation. Current laptops, for example, often require severe ulnar deviation of both hands to place them in the home position on the keyboard. The keypad disclosed herein may not induce any ulnar deviation of the hand.

Yet another advantage of the keypad is that it enables a combination of input modalities (e.g., voice, pointer, and keypad) which complement each other and further increase the comfort level and operating productivity of the user.

Still yet another advantage of the keypad is that it enables 2-dimensional translation to both modulate the mapping of the keypad, and to control an on-screen pointer.

Another advantage of the keypad is the orientation of ‘shift’, ‘alt’, and ‘ctrl’ keys, operable by the thumb, on adjacent and orthogonal axes that enable easy replication of common input with the use of only one hand. The orientation of the thumb keys may also be advantageous when implemented on any number of other keyboards (e.g., “QWERTY” keyboards), keypads, or known input devices, in addition to the single-hand keypad disclosed herein.

Still yet another advantage of the keypad is the ability to use the keypad together with an on-screen display that enables users to locate un-learned keys as well as keys that are used infrequently.

These and other objects, features, and advantages of the invention will be apparent through the detailed description of the preferred embodiments and the drawings attached hereto. It is also to be understood that both the foregoing general description and the following detailed description are exemplary and not restrictive of the scope of the invention.

### BRIEF DESCRIPTION OF THE DRAWINGS

FIG. 1 is a perspective view of a hand positioned on a single-hand keypad, according to an embodiment of the invention.

FIG. 2A is a schematic block diagram illustrating a keypad system, according to an embodiment of the invention.

FIG. 2B is a schematic block diagram illustrating a keypad system, according to an embodiment of the invention.

FIGS. 3A-3B depict schematic block diagrams of a keypad system, according to an embodiment of the invention.

FIG. 4 is a perspective view of a single-hand keypad, according to an embodiment of the invention.

FIG. 5 is an exemplary illustration of a translation mechanism enabling key multiplicity, according to an embodiment of the invention.

FIG. 6 is an exemplary illustration of a key, according to an embodiment of the invention.

FIG. 7 is an exemplary schematic of a top, side, and aft view of a single-hand keypad, according to an embodiment of the invention.

FIG. 8 is an illustration of exemplary left, right, forward, and aft domains of a single-hand keypad according to an embodiment of the invention.

FIG. 9 is an exemplary illustration of thumb keys (oriented on adjacent and orthogonal axes) implemented on a traditional input device, according to an embodiment of the invention.

FIGS. 10A-10C are exemplary illustrations of thumb key configurations, according to an embodiment of the invention.

### DETAILED DESCRIPTION OF THE INVENTION

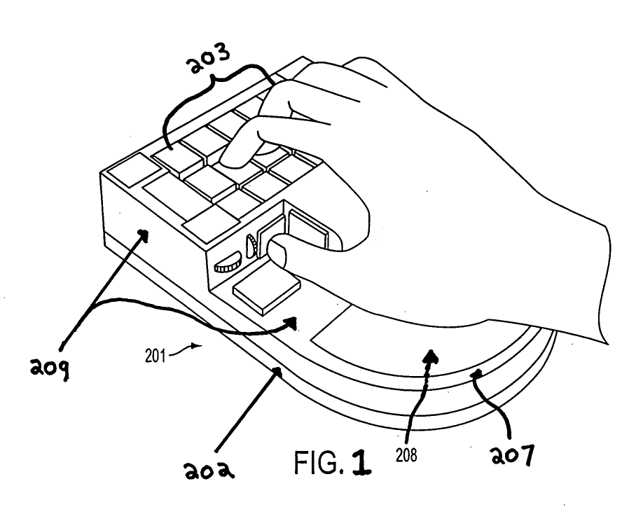

As a general overview, FIG. 1 illustrates a perspective view of a single-hand keypad 201 designed to enable convenient, effective, single-handed operation by either a left-handed or right-handed user. Keypad 201 incorporates a combination of input modalities (e.g., keypad, pointer device, voice recognition capability) to increase productivity.

According to an embodiment of the invention, keypad 201 may include a first portion 209 and a second portion or base 202. First portion 209 may include a key area 203 and a palm rest 207 extending from key area 203. In one embodiment, base 202 may be fixed (e.g., placed on a planar surface) and first portion 209 may move relative to base 202. As described in greater detail below, the movement of first portion 209 relative to fixed base 202 may control both pointer control (e.g., of a pointer arrow or other icon displayed on a graphical user interface) and key selection.

As described in greater detail below, key area 203 may comprise a predetermined number of keys that, although fewer in number than the keys on a conventional “QWERTY” keyboard, still include all of the functionality of a “QWERTY” keyboard as well as additional functionality described below.

In one implementation, a user may position his palm in a single, comfortable position on palm rest 207, and use his thumb and fingers to access all of the keys on keypad 201 without removing his palm from the single position on palm rest 207. The compact design of keypad 201 and the reduced number of keys facilitates this while still permitting “full-sized” keys to be used.

According to one embodiment, palm rest 207 may be positioned lower than keypad area 203 on first portion 209 to provide comfortable operation. Alternatively, palm rest 207 may be positioned on the same level as key area 203, or even above key area 203 depending on the needs of a particular user. Preferably, palm rest 207 is positioned for maximum wrist and hand comfort with little or no ulnar deviation.

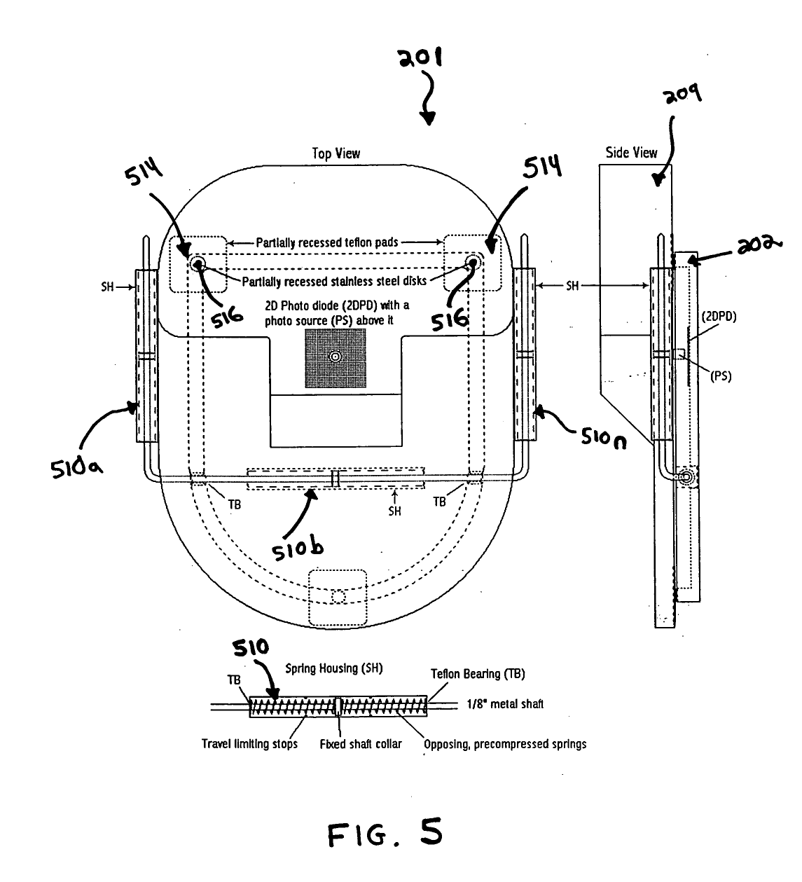

According to another embodiment of the invention, palm rest 207 may include a moldable contact portion 208. Moldable contact portion 208 may be formed with microspheres under a latex or spandex covering. As illustrated in FIG. 1, a user may rest his or her hand on moldable contact portion 208 such that the fingers and thumb may easily reach the respective keys. When the microspheres are depressed by the palm, they may conform to the shape of the palm and form a well supporting the hand. In addition to providing comfortable support, moldable contact portion 208 may couple first portion 209 to the palm so that the motion of the palm can effectuate movement of first portion 209 of keypad 201 relative to base 202 of keypad 201, as described in detail below. It should be understood that, in certain embodiments disclosed herein, a broad description of the “movement” of keypad 201 may actually refer to the movement of first portion 209 of keypad 201 relative to fixed base portion 202 of keypad 201. The mechanism or mechanisms enabling movement of first portion 209 relative to base 202 will be described in detail below, with regard to FIG. 5.

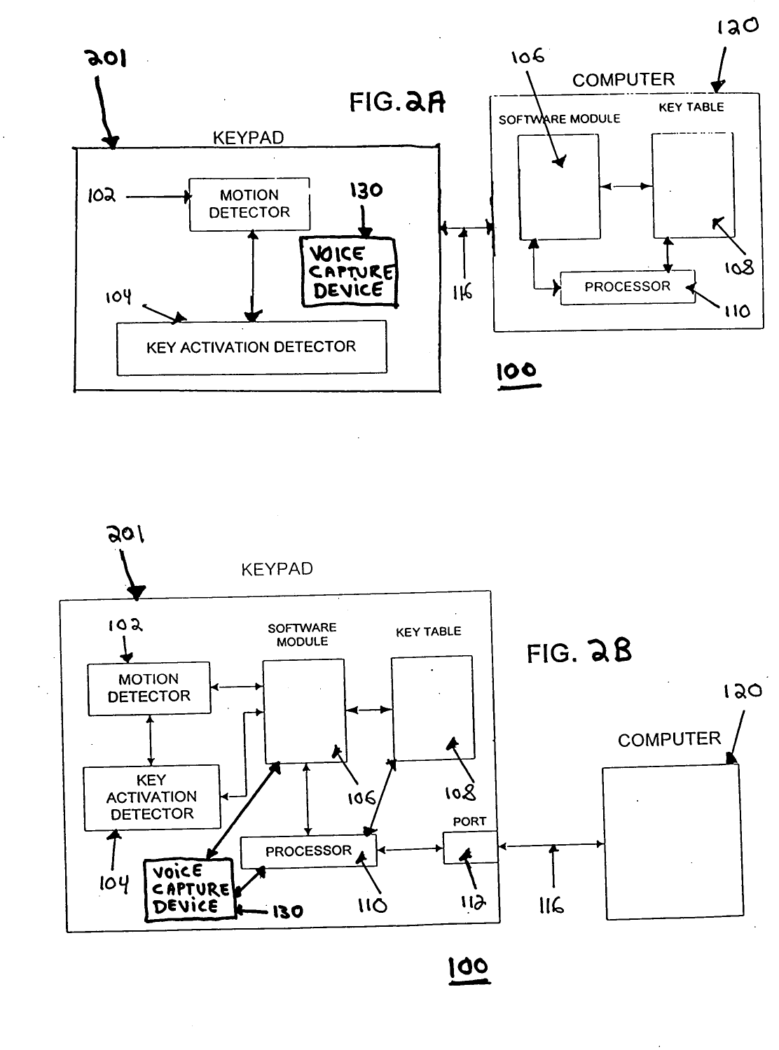

Prior to describing the various features and functionality of keypad 201, various keypad systems in which keypad 201 may be used will first be described with reference to FIGS. 2A-2B. It should be understood that the keypad systems illustrated in FIGS. 2A-2B are exemplary only. Additional configurations may be implemented according to various embodiments.

FIG. 2A is a schematic block diagram illustrating a keypad system 100. As illustrated in FIG. 2A, keypad 201 may communicate with and serve as an input device for a computer 120 via a wired or wireless communication link 116.

In one implementation, keypad 201 may comprise a motion detector 102 (e.g., a translational motion detection mechanism), and a key activation detector 104 (e.g., a key activation detection mechanism). Motion detector 102 may detect the motion of keypad 201 (or of first portion 209 relative to base 202) in any number of directions (e.g., left, right, forward, aft), thus enabling keypad 201 to also act as a pointer device. According to an embodiment, motion detector 102 may be similar to motion detection mechanisms commonly used with existing computer mouse devices, or other input devices. For example, motion detector 102 may comprise a mechanical ball, an optical sensor device, or other sensing device. Key activation detector 104 may be similar to mechanisms used with existing keypads to determine when one or more components of keypad 201 (e.g., a key, thumb-wheel, etc.) have been selected, depressed, or otherwise activated. According to one embodiment, the circuitry comprising motion detector 102 and key activation detector 104 may be housed within either or both of base 202 or first portion 209 of keypad 201. Other configurations may be used.

Keypad 201 may further comprise a voice capture device 130 for enabling input via spoken words or commands (e.g., voice recognition). Voice capture device 130 may comprise a microphone that is integral with either first portion 209 or base 202 of keypad 201. Alternatively, voice capture device 130 may comprise an external microphone adapted to be positioned near, or worn by a user, and coupled to an interface (e.g., jack) positioned either on first portion 209 or base 202 of keypad 201.

As a user manipulates keypad 201 (or first portion 209 relative to base 202) to provide input during a computing session, the output of motion detector 102 and key activation detector 104 may comprise electrical (or other) signals which may be provided as input to software module 106 of computer 120. Examples of computer 120 may include any one or more of, for instance, a personal computer, portable computer, PDA (personal digital assistant), workstation, dumb terminal, web-enabled mobile phone, WAP device, web-to-voice device, or other device.

According to one embodiment, computer 120 may comprise a processor 110, and a software module 106 for receiving inputs from motion detector 102 and/or key activation detector 104 of keypad 201. Software module 106 may further comprise voice recognition software (e.g., ViaVoice by IBM) to perform voice-to-text conversion on audio signals captured via voice capture device 130.

Additionally, software module 106 may be in communication with a key table 108 (e.g., a look-up table) or other table, repository, or database to determine an input based on a key activation and/or translational motion of keypad 201 (or first portion 209 relative to base 202) effectuated by a user. For example, software module 106 may be operable to determine whether activation for each key (or key combination activation) has occurred with or without translational movement of keypad 201 and, if so, information pertaining to the movement (such as the direction of movement). Based on these and/or other inputs, software module 106 may compare this information to values stored in key table 108. Key table 108 may include, among other data, a listing of which character values, commands, or other functions are assigned to a combination of keys and a translational movement.

According to an alternative embodiment illustrated in FIG. 2B, keypad 201 may comprise an integral unit including components enabling keypad 201 to act as a computer, portable computer, PDA or other computer device so as to provide a single interface for use with many different types of equipment in a variety of applications and environments.

For example, as illustrated, keypad 201 may comprise motion detector 102, key activation detector 104, voice capture device 130, software module 106, key table 108, processor 110, and an I/O port 112. Port 112 may comprise one or more of a serial port, parallel port, USB port, network port, or other port. Additional components (not illustrated) may be provided including, for example, one or more of (or a combination of) a modem, hard drive, floppy drive, CD-ROM drive, DVD drive, CPU, RAM, chipset, or any other component corresponding to a general purpose computer. In some implementations, not all components may be necessary. According to one embodiment, the aforementioned components and/or associated circuitry may be disposed in either or both of first portion 209 and base 202 of keypad 201.

According to an embodiment of the invention, keypad 201 may be linked via a wired or wireless communication link 116 to any display device (not illustrated) for display purposes, or to any type of computer (e.g., computer 120). As such, keypad 201 may further include a connector and associated circuitry for a display. A typical home office and/or workplace have a myriad of devices with displays including, for example, computers, PDAs, televisions, game consoles, WebTV connections, etc. The additional circuitry and connections in keypad 201 may be used to connect to one or more of these or other devices to provide necessary inputs. In this regard, a single interface—keypad 201—may be used with different types of electronic equipment.

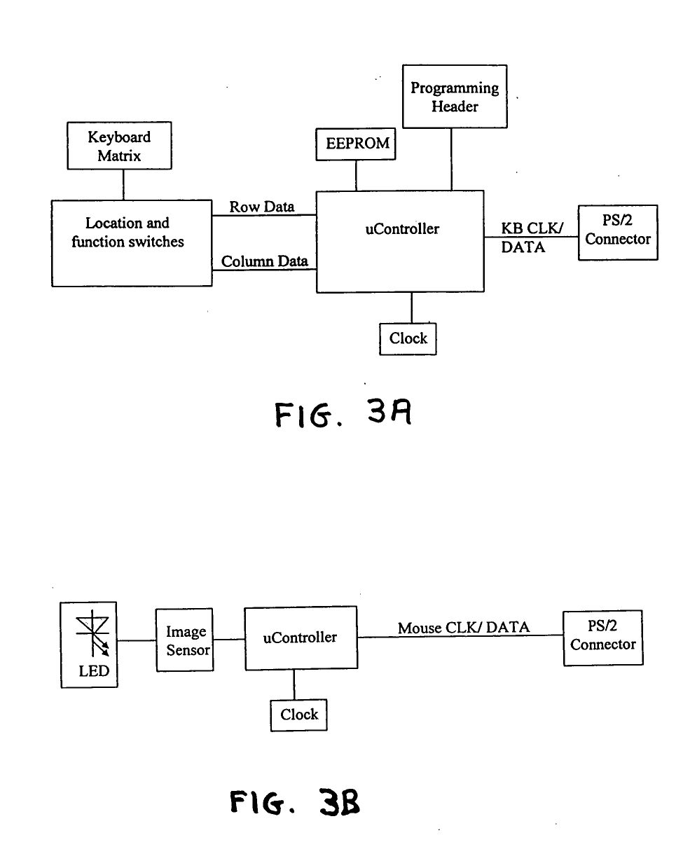

As recited above, the configurations illustrated in FIGS. 2A-2B are exemplary only, and other implementations may be used. For instance, FIGS. 3A-3B illustrate alternative schematic block diagrams of circuitry for keypad and pointer device (e.g., mouse) inputs, respectively. As shown, keypad and pointer control inputs may be provided to a standard computer device using the keyboard and mouse PS/2 com ports. The foundation of the keypad electronics may reside on a commercially available Semtech chip (SH1101FB QFP)—a user-programmable keyboard encoder with auto-detecting USB or PS/2 interface. According to one embodiment, rather than having the multifunction keys directly connected to the chip, they may be routed through custom circuitry such that that they may encode different matrix entries depending on the input mode and/or keypad domain. The pointer controller may communicate directly with the mouse port. Other configurations may be used.

Having provided a general overview of the various system configurations within which keypad 201 may be utilized, the features and functionality of keypad 201 will now be described.

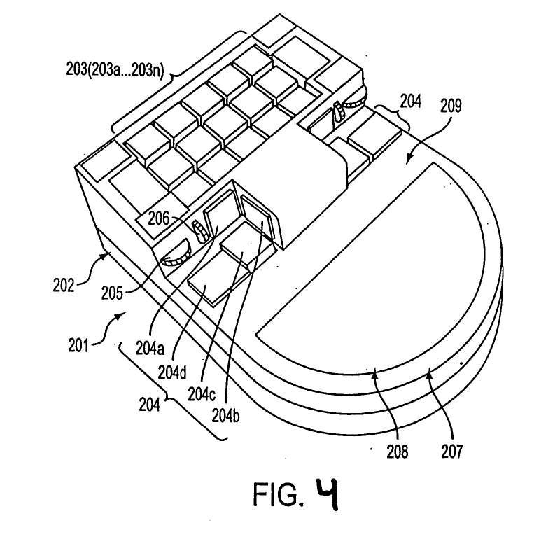

According to an embodiment of the invention illustrated in FIG. 4, key area 203 may include a predetermined number (e.g., seventeen) of keys (203a . . . 203n) operable by the fingers of a user, and a second set of thumb keys 204 operable by the right or left thumb of a user. Finger keys (203a . . . 203n) may be oriented in positions which are easily accessible (for operation) by a user. The positions may include an array structure and may include keys of different sizes.

Thumb keys 204, for example, may all be located in close proximity to a thumb position when a user's hand is at rest on keypad 201, but may be disposed in different orthogonal orientations. For example, keypad 201 may include at least three thumb keys (e.g., 204a, 204b, 204c), whereby one thumb key (e.g., 204a) may be activated by pushing the thumb forward, one (e.g., 204c) may be activated by pushing the thumb down, and one (e.g., 204b) may be activated by pushing the thumb sideways. In this manner, a user may operate any one, two, or all three keys substantially simultaneously. Additional keys (e.g., 204d) may be included in one or more of the directions.

According to another embodiment of the invention, thumb keys 204 may be activated individually or in various combinations to represent different character values, commands or other input. According to yet another embodiment of the invention, keypad 201 may include a set of redundant thumb keys 204′ to accommodate use by either hand, and provide an otherwise substantially symmetrical layout about a central axis of keypad 201.

According to an embodiment of the invention, keypad 201 may comprise at least two orthogonally-disposed scroll wheels (or thumbwheels) (205, 206), that permit scrolling respectively in a first direction (e.g., left and right), and in a second direction (e.g., up and down) preferably orthogonal to the first direction. Scroll wheels (205,206) may be located in close proximity to the thumb position and other thumb keys 204 to enable thumb actuated control of scroll wheels (205,206). Many current keyboards, mice, and laptop computers include scrolls for moving documents on a display. Scroll wheels (205, 206) may be used for these functions (e.g., moving a document left, right, up and down) as well as for other functions. A redundant set of scroll wheels may also be included with redundant thumb keys 204′.

According to an embodiment of the invention, the keys comprising keypad 201 may represent different character values or other inputs depending on the position or movement of the keypad 201 (or first portion 209 relative to base 202) when a key is depressed or otherwise activated. Character values may comprise any letter, number, mathematical operator or symbol, language symbol, command, or any other icon or symbol that may be represented on a keyboard.

According to one aspect of this embodiment, first portion 209 of keypad 201 may be moved in one or more linear directions (e.g., left, right, forward, aft) relative to base 202 of keypad 201 whereby the direction of movement (or non-movement) causes a key to represent a different character value when depressed, activated, or otherwise selected. This approach, for example, enables a single key to represent at least five different character values depending on whether keypad 201 is moved when a key is depressed, and if so, in which direction it is moved. Similar techniques may be used for keys that represent multiple commands (e.g., Enter, Delete, Page Up, Page Down, etc.) or other inputs.

As detailed below, one embodiment of the invention preferably uses two orthogonal directions of linear movement in addition to no movement (rest position) to enable some or all keys, depressed alone, to represent up to five different character values. In other embodiments, more (e.g., three) or less (e.g., one) dimensions of movement may be used. In alternative embodiments, other types of nonlinear movement (e.g., rocking) and/or the extent of movement, speed of movement, or other movement-related criteria may be used.

According to one embodiment, one or more keys may represent more than one character value or function based on motion (or direction of motion), and at least one key may represent the same value or function regardless of the motion or direction of motion.

One example of a translation mechanism enabling key multiplicity in keypad 201 is illustrated in FIG. 5. According to one embodiment of the invention, the translation mechanism comprises one or more spring housings or springs (510a, 510b, . . . 510n) coupling first portion 209 to base 202, and enabling first portion 209 to move relative to fixed base 202. Other mechanisms may be used to couple first portion 209 to base 202. When first portion 209 is in a different position relative to base 202, the internal circuitry may generate and transmit to the computer (or other electronic device) different character values for each of the keys when the keys are selected.

According to an embodiment, first portion 209 may move in at least two dimensions relative to base 202. Preferably, first portion 209 is moveable forward, backward, left, and right.

Additional dimensions (e.g., diagonal) may be implemented to provide further functionality.

The translation mechanism may center first portion 209 on base 202 in a “resting” position when first portion 209 is not being manipulated by a user. Additionally, first portion 209 may include a motion/position detector such as an optical sensor, trackball, or other mechanism (not shown) on the underside in contact with base 202. Preferably, translation may be measured with an optical system.

According to one embodiment, with springs (510a, 510b, . . . 510n) as diagrammed, displacement from the central, neutral, or “resting” position may have a force feedback similar to a joystick. Force feedback is usefull for feeling or selecting which domain (described below) is active for the keypad. According to one embodiment, partially recessed teflon pads 514 on the bottom of first portion 209 of keypad 201 align with stainless steel disks or pads 516 on base 202 to make a low-friction interface. Teflon bearings and shaft interfaces may also be low-friction.

Alternatively, the motion/position detector may be located in base 202. The optical sensor, trackball or other mechanism may be used to determine the position of first portion 209 relative to base 202. First portion 209 may also include an electrical connection (not shown) to a computer or other electronic device for which keypad 201 is operating as an input device. The electrical connection may include wired or wireless technologies, such as infrared transmission. Additionally, first portion 209 may include sufficient electronic circuitry to: (1) determine its position relative to base 202 using the optical sensor, trackball or other mechanism; (2) determine when and which keys are pressed or operated; and (3) to transfer information regarding the selected keys to the computer or other electronic device. Other translation mechanisms and configurations may be used.

According to an embodiment of the invention, visual indicators may be provided to further facilitate the use of keypad 201. Visual indicators may show, for example, which character values and/or commands are associated with which keys. According to one embodiment, the visual indicators may be located on the keys themselves, such that the different character values corresponding to a key are each displayed on the key, but are positioned on the key to correspond to the direction of movement that causes the key to produce, register, output, or otherwise “activate” that character value when depressed or selected.

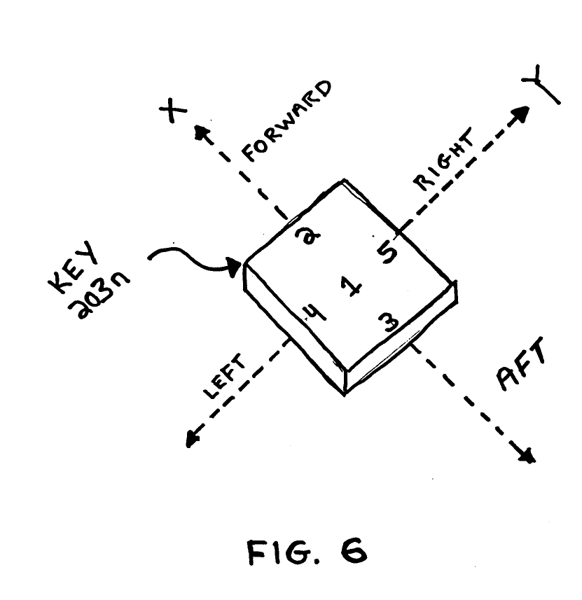

As an example, FIG. 6 illustrates a key (e.g., 203n) selected from the array of keys comprising key area 203 of keypad 201 depicted in FIG. 4. According to an embodiment, key 203n may be associated with five character values (or characters) such as, for example, the numbers 1, 2, 3, 4, and 5. Key 203n may represent each of the five characters (1, 2, 3, 4, 5) depending upon whether first portion 209 of keypad 201 is moved or not moved, and if moved, in which direction first portion 209 is moved relative to base 202. For instance, each number (1, 2, 3, 4, 5) may be assigned to a specific direction or non-direction, the assignment being recorded in key table 108 (see FIGS. 2A-2B). For example, if first portion 209 is stationary, key 203n may activate the number “1” when key 203n is depressed, selected, or activated by a user. Alternatively, if first portion 209 is moved forward and aft along the x-axis, key 203n may activate the numbers “2” and “3,” when depressed by a user in each respective position. Likewise, if first portion 209 is moved left and right along the y-axis, key 203n may activate the numbers “4” and “5,” when depressed by a user in each respective position. In other words, the numbers 1, 2, 3, 4, and 5 on the face of key 203n serve as visual indicators thus depicting the direction that first portion 209 should be moved relative to base 202 to activate the corresponding number.

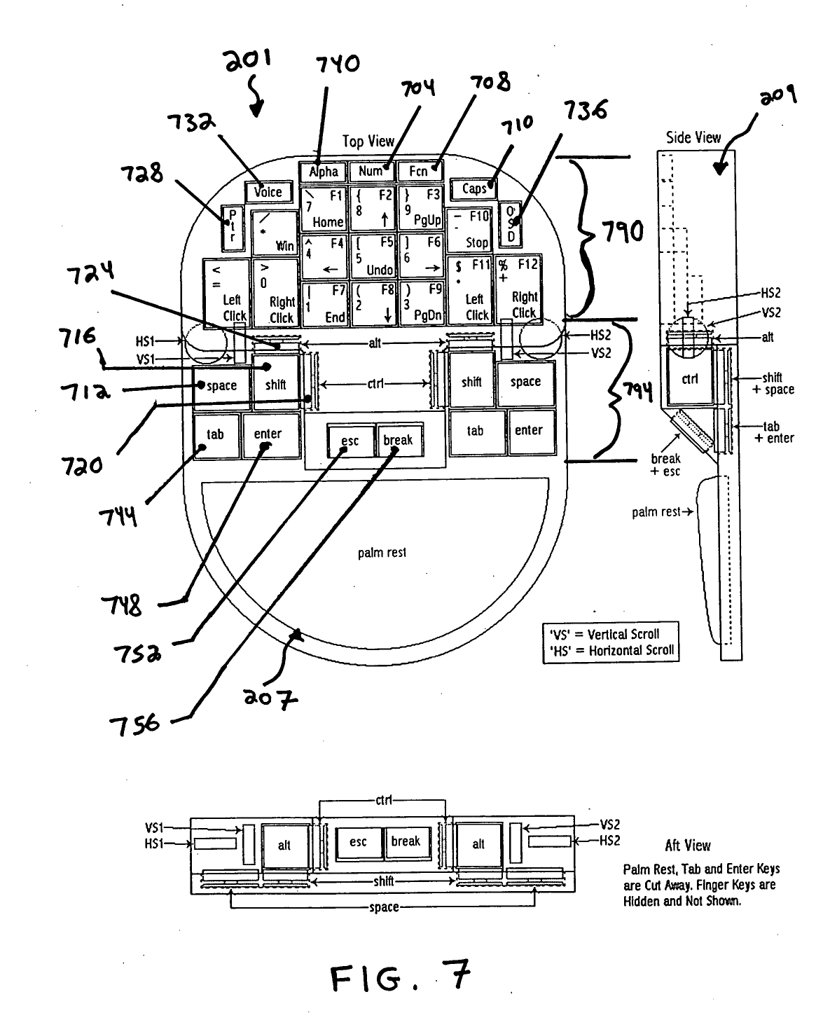

In certain embodiments, it may be impracticable to display all possible character values for a key on the face of the key, as illustrated in FIG. 6. As such, in an alternative embodiment, an on-screen display (OSD) or window may appear on a monitor or display of a computer device for which keypad 201 is serving as an input device. The on-screen window or display may illustrate a 2-D or 3-D rendering of keypad 201 and/or display one or more keys of keypad 201 and their corresponding character values based upon the position of keypad 201. The on-screen window or display may, for example, appear as a “pop-up” window in a particular software application being used by a user. One of the keys may provide a toggle to enable the user to selectively switch the on-screen display on and off. This feature will be described in greater detail below with regard to FIG. 7. Other visual indicator techniques may be used on or in conjunction with keypad 201.

According to another embodiment of the invention, the character values for each key may be indicated on a stand-alone display device (not illustrated) in operable communication with keypad 201. This embodiment may be used, for example, when keypad 201 is acting as its own computer (see, e.g., FIG. 2B).

Regardless of the embodiment, such an on-screen display feature assists users in determining which character value or function corresponds to each key. For instance, in various embodiments, the on-screen display may include a graphical representation of the keys as they appear on keypad 201. The corresponding character values may be displayed on the graphic representation of the keys. As first portion 209 of keypad 201 is moved to each of the four positions, the character values on the on-screen display may be changed. Note, however, that each key may be associated with at least five character values since the neutral position could be the fifth position as described previously. Additionally, menus for commands or special keys, such as quick-keys using the “shift,” “alt,” and “ctrl” keys, may be represented in the on-screen display. In this manner, a user can easily identify which key to press.

According to an alternative embodiment of the invention, keypad 201 may comprise a combination keypad and pointing device having at least two functional modes. In a first mode, and as already described, the keys of keypad 201 may represent different character values or other inputs depending on the position or movement of first portion 209 relative to base 202 when the keys are depressed, selected, or otherwise activated.

In a second mode, the movement of first portion 209 relative to base 202 may control the position of a cursor, icon, or other pointing device, or otherwise provide commands for pointer or cursor control. The same motion detection components described in detail above may be used for both functions. One advantage of this embodiment is that it eliminates the need for a separate mouse or trackball for control. Moreover, unlike full sized keyboards that include a separate pointer control, one or more keys used for the keypad may be used to actuate the pointer.

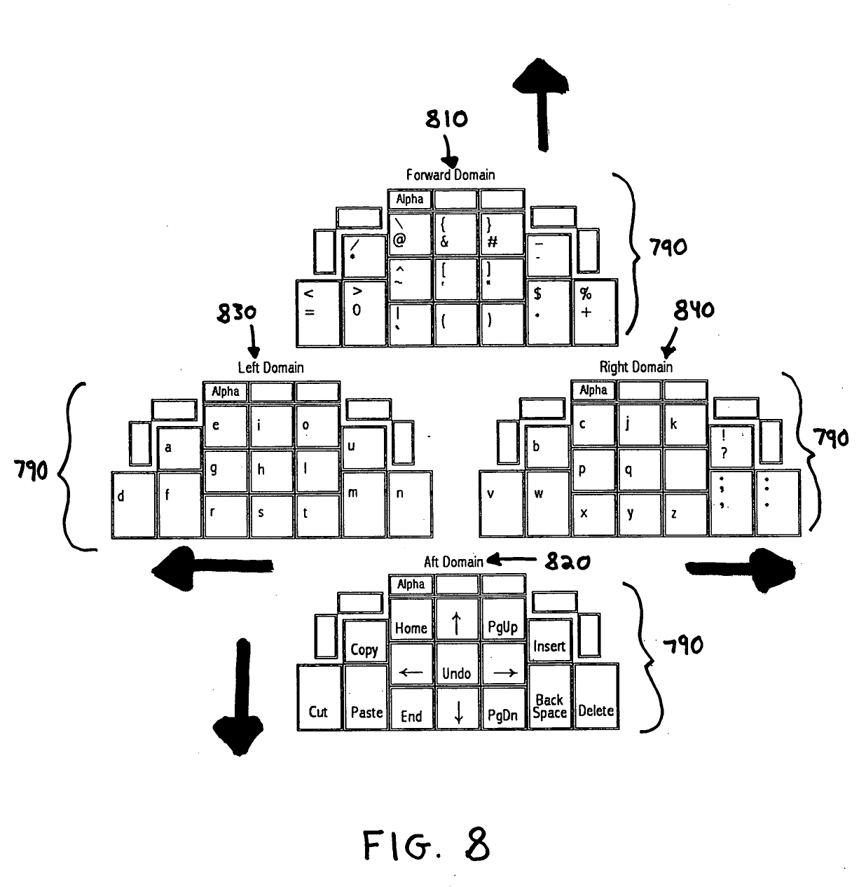

FIGS. 7-8 illustrate one particular implementation of single-hand keypad 201. FIG. 7 is an exemplary schematic of a top, side, and aft view of keypad 201 according to this implementation, while FIG. 8 illustrates left, right, forward, and aft domains of keypad 201 used in the implementation. It should be understood that the design and layout of keypad 201 illustrated in FIGS. 7-8 is exemplary only, and should not be viewed as limiting. In other embodiments, more or less keys may be provided in any number of configurations. Further, the character values assigned to each key in FIGS. 7-8 may differ in other embodiments.

As shown in FIG. 7, keypad 201 comprises two main key areas. A first key area 790 comprises keys primarily activated by fingers, including a series of multifunction keys comprising, for example, PTR 728, VOICE 732, ALPHA 740, NUM 704, FCN 708, CAPS 710, and OSD 736, the function of each of which will be explained below. In different embodiments, the number and function of multifunction keys may vary. First key area 790 also includes an additional selection of keys which will be described in greater detail below.

A second key area 794 includes four thumb keys, SPACE 712, SHIFT 716, CTRL 720, and ALT 724, which perform the same functions as they would on a standard keyboard. Two additional keys, TAB 744 and ENTER 748 are also provided that may be activated by the thumb. A “mirror” set of each of the four thumb keys (SPACE, SHIFT, CTRL, and ALT) and the TAB and ENTER key are also included in second key area 794 so as to accommodate both left-handed and right-handed users. Second key area 794 further comprises ESC 752 and BREAK 756 keys which also perform the same functions as they would on a standard keyboard. In one embodiment, the ESC 752 and BREAK 756 keys may be positioned such that a user's fingers or thumb have to reach or otherwise move from a resting position to activate them. Such a design may ensure that inadvertent keystrikes of the ESC 752 and BREAK 756 keys do not cause applications to stop running.

With regard to first key area 790, most computer users are familiar with multifunction keys. For example, the keys on a standard keyboard number pad have multiple functions. When ‘num lock’ is on, for example, the keys represent numbers, whereas when ‘num lock’ is off they represent navigation keys (e.g., arrows, home, end, page-up, and page-down). In similar fashion, NUM 704 and FCN 708 (function lock) keys may be activated to have keypad 201 represent arithmetic keys (e.g, numbers and associated symbols) and function keys, respectively.

As an example, in FIG. 7, when NUM 704 key is activated, the finger keys represent that which is depicted in the upper-left comer of the key. When FCN 708 key is activated, the finger keys represent that which is indicated in the upper-right comer of the key. Similar to known keyboards, CAPS 710 key may be toggled on and off to produce upper-case and lower-case letters, respectively.

According to one embodiment, selection of VOICE 732 key may activate voice-to-text conversion. This enables a user to input data and commands via voice capture device 130 as described above in reference to FIGS. 2A-2B.

When PTR (pointer) 728 key is activated, the movement of first portion 209 relative to base 202 of keypad 201 may control the position of a cursor, icon, or other pointing device, or otherwise provide commands for pointer or cursor control, as described above. Additionally, in this mode, the finger keys may represent that character value which is depicted on the lower portion of the key.

With regard to the remaining keys in first key area 790 (e.g., the alpha, punctuation, and editing keys), two-dimensional translation of keypad 201 is used to achieve the necessary duplicity. In other words, the movement of first portion 209 of keypad 201 in one or more linear directions (e.g., left, right, forward, aft) relative to base 202 of keypad causes a key to represent a different character value when depressed, activated, or otherwise selected in each position.

Selecting ALPHA 740 key places the keypad in ‘alpha’ mode, wherein the finger keys represent different values depending on how the keypad has been translocated from its central, resting, or neutral position.

FIG. 8 diagrams the mapping of the different character values that the keys of first key area 790 may represent, in alpha mode, when first portion 209 of keypad 201 is moved forward, aft, left, and right relative to fixed base 202 of keypad 201, and the keys are depressed, selected, or activated by a user. There are four domains (forward 810, aft 820, left 830, and right 840) whose names indicate the direction that first portion 209 must be moved relative to base 202 to activate the desired character values. The keys are preferably grouped into their domains based on frequency of use to minimize the number of keypad 201 translocations. Other mapping strategies may be utilized. When first portion 209 is not being displaced from the center, neutral, or resting position, the domain may be that which was last used. Other setings and configurations are possible. Additional domains (e.g., neutral position, diagonal directions, etc.) may be defined to represent additional character values for the keys.

In FIG. 8, of the upper row keys, only ALPHA 740 key is shown. This helps emphasize that the key mappings depicted are for the alpha mode. Forward domain 810 illustrates the character values of the keys of first key area 790 when first portion 209 of keypad 201 is moved forward relative to fixed base 202 of keypad 201, and the keys are selected by a user. In forward domain 810, the keys may represent various punctuation marks and symbols.

Aft domain 820 illustrates the character values of the keys of first key area 790 when first portion 209 of keypad 201 is moved aft (backward) relative to fixed base 202 of keypad 201, and the keys are selected by a user. In aft domain 820, the keys may represent various editing keys (e.g., ‘backspace’) and navigation keys. While editing or scrolling through a document, for example, keypad 201 may mostly reside in aft domain 820.

Left domain 830 illustrates the character values of the keys of first key area 790 when first portion 209 of keypad 201 is moved left relative to fixed base 202 of keypad 201, and the keys are selected by a user. In left domain 830, the keys may represent the major alpha keys most commonly used (e.g., ‘a’, ‘e’, ‘i’, ‘o’, ‘u’, ‘d’, ‘f’, ‘g’, ‘h’, ‘l’, ‘m’, ‘n’, ‘r’, ‘s’, and ‘t’). Since these keys account for more than 80% of keystrikes, keypad 201 may mostly reside in left domain 830 during the typing of text.

Right domain 840 illustrates the character values of the keys of first key area 790 when first portion 209 of keypad 201 is moved right relative to fixed base 202 of keypad 201, and the keys are selected by a user. In right domain 840, the keys may represent the minor alpha keys least frequently used (e.g., ‘b’, ‘c’, ‘j’, ‘k’, ‘v’, ‘w’, ‘p’, ‘q’, ‘x’, ‘y’, ‘z’, etc.) and other punctuation marks.

According to an embodiment, form-fitting palm rest 207 directly couples palm motion to the motion of first portion 209 of keypad 201. In so doing, the various keypad domains may be comfortably induced by movement of the palm.

In one embodiment, all possible character values for a key may be depicted on the key.

In alternative embodiments, only one or more of the character values represented by any key may be shown on the face of the key. To assist users in locating the correct alpha, punctuation and symbol keys, an OSD 736 key may be provided, which stands for “on-screen display.” When activated, it may trigger a “pop-up” keypad diagram on a display (e.g., on a computer screen), that may display the keypad mapping for the particular domain that is active. When keypad 201 is translocated to a new domain, the on-screen diagram may be updated.

According to an embodiment, the on-screen display or diagram may also display the mapping of various finger keys when keypad 201 is in various function modes depending on which of NUM 704, FCN 708, PTR 728, and CAPS 710 keys have been activated. Light-emitting diodes may also be placed on keypad 201 in a location near each of the multifunction (or other keys) to indicate which mode is active, as well as, for example, whether or not voice-to-text conversion is active (e.g., VOICE 732 key). Other implementations and configurations may be used.

With regard to second key area 794 (FIG. 7), the SPACE 712, SHIFT 716, CTRL 720, and ALT 724 keys actuated by the thumb may, in one embodiment, comprise non-multifunction keys. The thumb keys may be non-multifunction keys in that they always represent the character value that is indicated on the face of the key.

In one implementation, the SHIFT 716, CTRL 720, and ALT 724 keys may be positioned on adjacent yet orthogonal axes. Since the thumb can provide pressing power in all directions, each of the aforementioned keys may be depressed singly, any two at once, or all three together. This configuration enables all the key combinations of standard keyboards.

Second key area 794 may also comprise horizontal and vertical scrolls positioned for convenient manipulation by the thumb. In general, the thumb may perform more tasks with keypad 201 than with traditional keyboards. Yet, the thumb has a large range of motion and can apply much pressing power in varying directions (extension, flexion, abduction, adduction, and planar flexion). Due to its size and power, the thumb is less prone to repetitive stress injury from key strikes than are the minor phalanges.

Additionally, with regard to second key area 794, the SPACE 712 key is perhaps the most commonly used key when typing text. As such, SPACE 712 key may be placed within easy reach of the thumb—just as in standard keyboards. TAB 744 and ENTER 748 keys are also used commonly with database programs and dialog boxes, so they may be positioned within easy reach of the thumb. Other implementations and configurations may be used.

In addition to the foregoing description, alternative embodiments may exist. As one example, in certain embodiments, rather than first portion 209 of keypad 201 moving relative to fixed base 202, the entire keypad 201 may be used like a mouse or other pointer controller such that movement along a planar surface is detected by a roller system, an optical sensor, or other detection system or technique used in pointing devices.

In still other embodiments, keypad 201 may be used in “free-space.” For example, keypad 201 may be worn by a user via a glove assembly or other device, and movement may be detected without requiring keypad 201 to be moved along a surface. This embodiment may be applicable to a variety of mobile applications including, for example, use with wearable computers. In this embodiment, movement may be detected by using known three-dimensional (3-D) motion and/or position detection techniques.

In yet other embodiments, keypad 201 may be functional in both a “table-top” mode, and in a “free-space” mode, comprising suitable motion and/or position detection devices to accommodate both techniques. Mode selection may be controlled by a predetermined key of keypad 201, via a toggle switch, or may be automatically detected.

Additionally, as recited above, the configuration of thumb keys described herein and illustrated in, for example, FIGS. 1, 4, and 7, may be implemented on any number of other devices in addition to the single-hand keypad disclosed herein. Any number of thumb keys positioned on adjacent and orthogonal axes may be implemented on, for instance, electric typewriters, any number of different keyboards (e.g., “QWERTY” keyboards), keypads, or other known input devices, without limitation, whether or nor they are associated with a computing device or not.

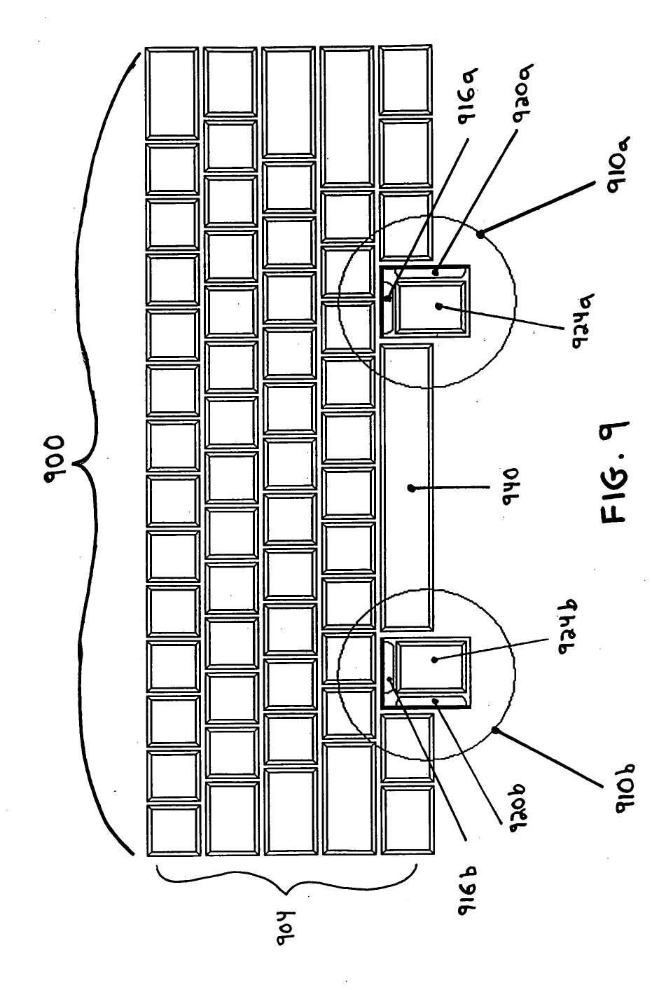

FIG. 9 illustrates, for example, an input device 900 comprising an array 904 of keys. Array 904 may comprise one or more rows or columns of keys arranged in any number of different configurations. According to one exemplary embodiment, input device 900 may comprise a “QWERTY” keyboard.

As illustrated, one row of keys comprising array 904 may include a first cluster of thumb keys 910a including SHIFT 916a, CTRL 920a, and ALT 924a keys, which perform the same functions as they would on a standard keyboard, and which may be operated by the right thumb of a user. A “mirror” set of thumb keys may also be provided as illustrated by the second cluster of thumb keys 910b including SHIFT 916b, CTRL 920b, and ALT 924b keys, which perform the same functions as they would on a standard keyboard, and which may be operated by the left thumb of a user.

The first and second clusters of thumb keys (910a, 910b) may be separated by a SPACE 940 key (e.g., a spacebar) or other key. As recited above, the SPACE 940 key is perhaps the most commonly used key when typing text. As such, SPACE 940 key and the first and second clusters of thumb keys (910a, 910b) may be positioned so as to be located in close proximity to the positions of a user's thumbs when the user's hands are located in a rest or neutral position on input device 900.

In various embodiments, it should be recognized that the keys comprising the first and second clusters of thumb keys (910a, 910b) may vary in number, may be sized differently, and may perform functions other than those of SHIFT, CTRL, and ALT keys.

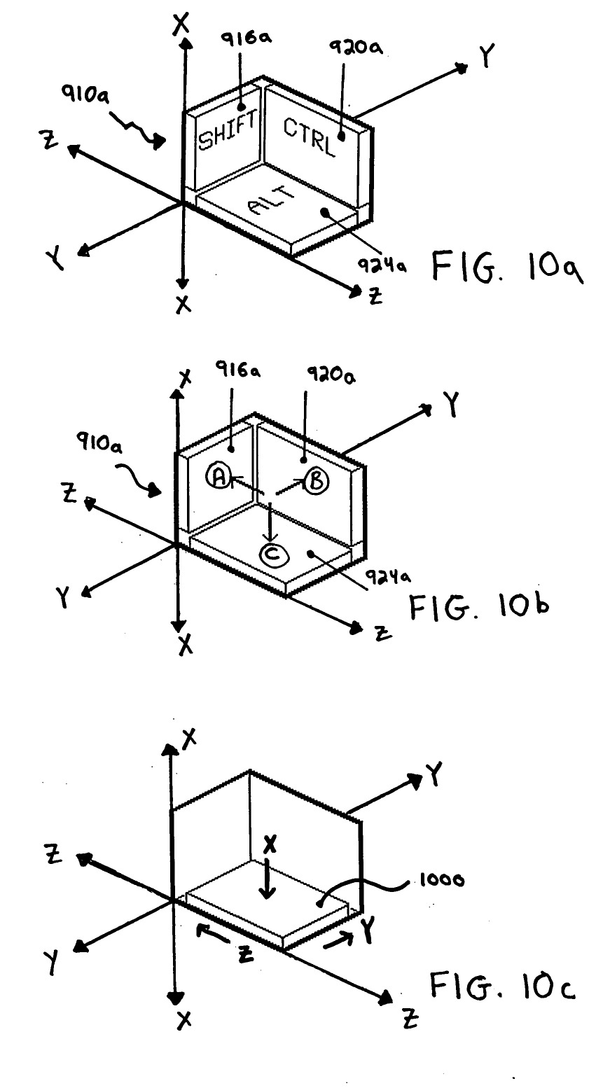

The actuation and functionality of the thumb keys is now described with reference to FIGS. 10A-10C. For ease of explanation, FIGS. 10A-10C will focus on the first cluster 910a of thumb keys. As illustrated in FIG. 10A, a set of three-dimensional axes (the XYZ axes) define an XY-plane, an XZ-plane, and a YZ-plane. The SHIFT 916a, CTRL 920a, and ALT 924a keys are oriented on the substantially adjacent and orthogonal planes such that SHIFT 916a key is oriented on the XY-plane, CTRL 920a key is oriented on the XZ-plane, and ALT 924a key is oriented on the YZ-plane. Accordingly, SHIFT 916a key may be activated by pushing the thumb forward in the direction of ARROW “A” illustrated in FIG. 10B, CTRL 920a key maybe activated by pushing the thumb sideways in the direction of ARROW “B” illustrated in FIG. 10B, and ALT 924a key may be activated by pushing the thumb down in the direction of ARROW “C” illustrated in FIG. 10B. Each of the foregoing movements may be made from a resting or “neutral” position of the thumb. In this manner, a user may operate any one, two, or all three keys substantially simultaneously. Additional keys may be included in one or more of the directions. According to another embodiment of the invention, the thumb keys may be activated individually or in various combinations to represent different character values, commands or other input.

According to an embodiment of the invention illustrated in FIG. 10C, transducers for motion in the X, Y, and Z directions may be positioned in a key 1000 that lies in the YZ-plane. FIGS. 10A and 10B illustrate one embodiment wherein each of the SHIFT 916a, CTRL 920a, and ALT 924a keys may have a transducer positioned directly below the key face, as is common with “traditional” keys on a typical keyboard or other input device. In FIG. 10C, with the exception of enabling force in the X direction, the housing of key 1000 may be rigid such that Y-force applied to the side in the XZ-plane may move the entire housing in the Y direction, and Z-force applied to the side in the XY-plane may move the entire housing in the Z direction. Sensors in key 1000 may detect the Y or Z motion or force applied to the housing of key 1000. As with the prior embodiments, X, Y, and Z motion or force can be induced by the thumb singly, any two together, or all three at once. The advantage of this embodiment is that the sides (e.g., the portions that lie in the XY and XZ-planes) of key 1000 may be thin and have a low profile. The sides may only need to be high enough off the surface of the keypad or other input device to engage the thumb, and thick enough to support the load applied to them.

In various alternative implementations, the foregoing embodiments (which refer to thumb keys) may be equally applicable to any cluster or grouping of any number of keys, positioned at any location on an input device (e.g., a keyboard), and operable by any digit or combinations of digits of a user (e.g., fingers or thumb), for performing any number of functions (e.g., inputting characters, data, commands, or serving as function keys, etc.).

Other embodiments, uses and advantages of the invention will be apparent to those skilled in the art from consideration of the specification and practice of the invention disclosed herein. As such, the specification should be considered exemplary only, and the scope of the invention is accordingly intended to be limited only by the following claims.

What is claimed is:

1. An input device, comprising:
an array of keys for inputting character values, data, or commands when selected, the array of keys further comprising at least one cluster of two or more thumb keys positioned so as to be operable by a thumb of a user, and wherein the two or more thumb keys are oriented in substantially orthogonal and adjacent planes.

2. The input device of claim 1, wherein the two or more thumb keys comprise a first thumb key, a second thumb key, and a third thumb key.

3. The input device of claim 2, wherein a user selects the first thumb key by pushing the thumb in a forward direction, from a neutral, resting position.

4. The input device of claim 3, wherein the first thumb key comprises a SHIFT key.

5. The input device of claim 2, wherein a user selects the second thumb key by pushing the second thumb in a sideways direction, from a neutral, resting position.

6. The input device of claim 5, wherein the second thumb key comprises a CTRL key.

7. The input device of claim 2, wherein a user selects the third thumb key by pushing the third thumb key in downward direction, from a neutral, resting position.

8. The input device of claim 7, wherein the third thumb key comprises an ALT key.

9. The keypad of claim 2, wherein the first thumb key, second thumb key, and third thumb key may be selected by a user either individually or in combination.

10. A keyboard, for with use with a computing device, comprising:
an array of keys for inputting character values, data, or commands when selected, the array of keys further comprising a first thumb key, a second thumb key, and a third thumb key, each of which are positioned in substantially orthogonal and adjacent planes to one another so as to be operable by a thumb of a user to enable the user to select the first thumb key, second thumb key, and third thumb key either individually or in combination.

11. A keyboard, for with use with a computing device, comprising:
an array of keys for inputting character values, data, or commands when selected, the array of keys further comprising at least one cluster of three keys positioned in substantially orthogonal and adjacent planes so as to be operable either individually or in combination by at least one digit of a user's hand, the at least one cluster of three keys further comprising:
a first key that may be selected by a user when the at least one digit of the user's hand is moved forward from a neutral, resting position;
a second key that may be selected by a user when the at least one digit of the user's hand is moved sideways from a neutral, resting position; and
a third key that may be selected by a user when the at least one digit of the user's hand is moved downward from a neutral, resting position.
